(19) United States
(12) Patent Application Publication
(10) Pub. No.: US 2026/0021974 A1
(43) Pub. Date: Jan. 22, 2026

(54) Transporting Device, System and Associated Method

(71) Applicant: GHS Technologies GmbH, Hergiswil (CH)

(72) Inventor: Franco CARMAGNOLA, Romentino (NO) (IT)

(21) Appl. No.: 19/092,388

(22) Filed: Mar. 27, 2025

(30) Foreign Application Priority Data
Jul. 16, 2024 (CH) CH000762/2024
Jul. 16, 2024 (IT) 102024000016477

(51) Int. Cl. B65G 47/24; B65G 43/08; B65G 47/54

(52) U.S. Cl. CPC B65G 47/24; B65G 43/08; B65G 47/54

(57) ABSTRACT

A transporting device includes a supporting element configured to be fixed to a supporting structure, a head portion connected to the supporting element, the head portion including at least a primary translator for objects to be transported, and configured to translate the objects to be transported along at least one first predefined translation direction. The transporting device further includes a rotation actuator configured to rotate the head portion with respect to the supporting element along a rotation axis inclined with respect to the first predefined translation direction. The transporting device is configured to singularize at least one first and one second object to be transported at least partially superimposed and respectively arranged at a first height and at a second height at least partially arranged in correspondence of the head portion determining a fall of the second object to be transported from the second height to the first height.

### CROSS-REFERENCE TO RELATED APPLICATIONS

This application claims priority to, and the benefit of Italian Patent Application No. 102024000016477, filed Jul. 16, 2024, and Swiss Patent Application No. CH000762/2024, also filed Jul. 16, 2024. Both of said applications are incorporated by reference as if fully set forth herein.

### FIELD OF THE ART

The present disclosure refers to a transporting device, and in particular a transporting device for objects of various type, configured to move these objects by means of roto-translational movements.

The present disclosure also concerns a transporting system that comprises the transporting device object of the present disclosure.

The present disclosure concerns also a method for moving objects by means of the transporting device object of the present disclosure.

### KNOWN ART

Many types of objects are handled in distribution locations, collection locations, warehouses or similar. In some cases, a large number of objects is classified and loaded on trucks or transported on specific shelves by means of transporting systems.

Such transporting systems can comprise simple conveyor belts or can be defined by a matrix of transporting devices each one having a rotating head and comprising elements destined to determine the translation of at least one object to be transported with respect to said transporting head.

Transporting devices with aggregate wheels are known, as schematically represented in FIG. 1. These wheels 1 have an extremely limited contacting surface 2, and provide as a whole a substantially non-planar transporting surface for an object to be transported 4.

Transporting systems with aggregate wheels are disadvantaged by the reciprocal separation 5 among the wheels and by the non-uniformity (in particular, lack of planarity) of the contacting surface 2.

US2019/0135542 describes a transporting system comprising pods.

EP 3 733 567 A1 discloses a device for moving loads that allows to separate two stacked objects by means of centrifugal force induced by a rotation on a plane determined by an activation of a plurality of transporting cells.

The document KR 101 845 929 discloses a system for classifying objects that comprises a supporting plate and a plurality of cells each one thereof integrates an actuator configured to raise or lower a support in order to identify a barrier that assists the directing of the objects to be transported.

These transporting devices detect as a whole a substantially planar surface.

The assembly of the transporting devices allows to separate (singularize) two or more objects to be transported by means of translation or separation.

The purpose of the present disclosure is to describe a transporting device that allows to improve the separation performance of two or more objects to be transported.

### SUMMARY

When handling large quantities of objects, it can often occur that these objects arrive on the transporting systems in a superimposed way.

For this purpose, it has been conceived a transporting device, the main aspects thereof are described below. These aspects can be combined with each other or with portions of the detailed description or of the claims.

According to a first independent aspect is herein described a transporting device (100), comprising:
a supporting element (101) configured to be fixed to a supporting structure (210);
a head portion (102) connected to the supporting element (101), the head portion (102) comprising at least a primary translator (103) for objects to be transported (400), configured to translate said objects to be transported (400) along at least one first predefined translation direction (X),
a rotation actuator (104), configured to rotate said head portion (102) with respect to said supporting element (101) along a rotation axis (Y) inclined with respect to said first predefined translation direction (X);
wherein said transporting device (100) is configured to singularize at least one first and one second object to be transported (400) at least partially superimposed and respectively arranged at a first height (L1) and at a second height (L2) at least partially arranged in correspondence of said head portion (102) determining a fall of said second object to be transported (400) from said second height (L2) to said first height (L1).

According to a further independent aspect is furthermore herein described a method for moving objects to be transported, comprising:
arranging at least one first object to be transported (400) in correspondence of at least one transporting device (100) according to one or more of the aspects herein described;
carrying out an activation of said transporting device (100) in order to move said at least one first object to be transported (400), determining a translation of said at least one first object to be transported (400) along said first predefined translation direction (X) and/or a rotation of said at least one first object to be transported (400) with respect to said rotation axis (Y), and/or a translation of said at least one first object to be transported (400) along a direction substantially parallel to said rotation axis (Y).

According to another non-limiting aspect, the activation of said transporting device (100) determines a vibrating motion of said at least one first object to be transported (400), optionally of said first object to be transported (400) and of said second object to be transported (400), along a direction substantially parallel to said rotation axis (Y).

According to another non-limiting aspect, the method comprises:
arranging at least one second object to be transported (400) in correspondence of said at least one transporting device (100), wherein the second object to be transported (400) is arranged above said first object to be transported (400) and lies at a second height (L2) higher with respect to a first height (L1) at which lies said first object to be transported (400),
and wherein the activation of said transporting device (100), determines a fall of said second object to be transported (400) from said second height (L2) to said first height (L1).

According to another non-limiting aspect, the transporting device (100) comprises a secondary translator (105) configured to cause a translation of at least one part of said head portion (102), preferably at least said primary translator (103), along a direction substantially parallel to said rotation axis (Y) with respect to said supporting element (101).

According to another non-limiting aspect, said secondary translator (105) comprises, or is, a vibrator.

According to another non-limiting aspect, said secondary translator (105) is independently activatable with respect to said rotation actuator (104).

According to another non-limiting aspect, said method comprises activating said secondary translator (105) independently with respect to said rotation actuator (104).

According to another non-limiting aspect, the activation of said device translator (100) comprises the activation of a secondary translator (105) of said device translator (100).

According to another non-limiting aspect, the activation of said secondary translator (105) determines a translation cyclic, and/or reciprocating with an ascending and descending movement, along a direction substantially parallel to said rotation axis (Y) of at least said head portion (102) and/or of said primary translator (103).

According to another non-limiting aspect, said translation cyclic, and/or reciprocating with an ascending and descending movement, along a direction substantially parallel to said rotation axis (Y) determines a corresponding movement of translation along a direction substantially parallel to said rotation axis (Y) of said first object to be transported (400) and of said second object to be transported (400).

According to another non-limiting aspect, said method comprises an activation of said secondary translator (105) independently from said primary translator (103) and/or in substantial simultaneity with said primary translator (103).

According to another non-limiting aspect, the activation of said secondary translator (105) determines said translation, with a variable frequency between a first minimum value and a second maximum value.

According to another non-limiting aspect, said method comprises carrying said first object to be transported (400) and said second object to be transported (400) from a condition at least partially superimposed to a condition wherein said first object to be transported (400) and said second object to be transported (400) substantially lie at a same height, by means of said substantially translatory cyclic and/or reciprocating movement.

According to another non-limiting aspect, said second object to be transported (400) lies at a second height (L2) higher with respect to a first height (L1) at which lies said first object to be transported (400).

According to another non-limiting aspect, said same height corresponds to said first height (L1).

According to another non-limiting aspect, said primary translator (103) is independently activatable with respect to said rotation actuator (104) and/or with respect to said secondary translator (105).

According to another non-limiting aspect, the method comprises activating said primary translator (103) in an independent way with respect to said rotation actuator (104) and/or with respect to said secondary translator (105).

According to another non-limiting aspect, said secondary translator (105) is configured to determine a vibration of said first object to be transported (400) and, preferably, of said second object to be transported (400), along said rotation axis (Y).

According to another non-limiting aspect, said transporting device (100) is configured to singularize said objects to be transported (400) by means of at least one among an activation of said rotation actuator (104), an activation of said primary translator (103), an activation of said secondary translator (105), optionally by means of a composite and simultaneous, and/or sequential, movement of rotation of said head portion (102) on said rotation axis (Y) and of translation along said predefined translation direction (X) determined by the simultaneous, and/or sequential, activation, of said rotation actuator (104) and of said primary translator (103), or by means of a composite and simultaneous, and/or sequential, movement of rotation of said head portion (102) on said rotation axis (Y) and of translation along said rotation axis (Y) determined by the simultaneous activation of said rotation actuator (104) and of said secondary translator (105), or by means of a composite and simultaneous, and/or sequential, movement of, of translation along said predefined translation direction (X) and along said rotation axis (Y) determined by the simultaneous, and/or sequential, activation, of said primary translator (103) and of said secondary translator (105).

According to another non-limiting aspect, the activation of said transporting device (100) comprises an activation of a secondary translator (105) configured to cause a translation of at least one part of said head portion (102), preferably at least of said primary translator (103), along a direction substantially parallel to said rotation axis (Y) with respect to said supporting element (101).

According to another non-limiting aspect, said translation induced by said secondary translator (105) is a translation cyclic, and/or reciprocating with an ascending and descending movement.

According to another non-limiting aspect, the activation of said transporting device (100) comprises at least one among an activation of said rotation actuator (104), an activation of said primary translator (103), an activation of said secondary translator (105), optionally by means of a composite and simultaneous, and/or sequential, movement of rotation of said head portion (102) on said rotation axis (Y) and of translation along said predefined translation direction (X) determined by the simultaneous, and/or sequential, activation, of said rotation actuator (104) and of said primary translator (103), or by means of a composite and simultaneous, and/or sequential, movement of rotation of said head portion (102) on said rotation axis (Y) and of translation along said rotation axis (Y) determined by the simultaneous, and/or sequential, activation, of said rotation actuator (104) and of said secondary translator (105), or by means of a composite and simultaneous, and/or sequential, movement of translation along said predefined translation direction (X) and along said rotation axis (Y) determined by the simultaneous, and/or sequential, activation, of said primary translator (103) and of said secondary translator (105), determining a singularization of said second object to be transported (400) with respect to said first object to be transported (400) by means of said fall of said second object to be transported (400) from said second height (L2) to said first height (L1).

According to another non-limiting aspect, said rotation axis (Y) is orthogonal with respect to said first predefined direction (X).

According to another non-limiting aspect, said primary translator (103) is configured to translate said objects to be transported (400) along a predefined plane (X-Z).

According to another non-limiting aspect, said first predefined translation direction (X) lies on said predefined plane (X-Z).

According to another non-limiting aspect, said supporting element (101) comprises a lower portion (101i) and an upper portion (101u) rotatably engaged on said lower portion (101i).

According to another non-limiting aspect, said upper portion (101u) is configured to determine a dragging of said head portion (102) in rotation on said rotation axis (Y).

According to another non-limiting aspect, said transporting device (100) comprises engaging elements (101n, 102r) in form of rib and corresponding recess, arranged in correspondence of said upper portion (101u) of said supporting element (101) and of said head portion (102), preferably of a base of the head portion (102), configured to be coupled by introduction and to determine the dragging of said head portion (102) in rotation on said rotation axis (Y).

According to another non-limiting aspect, the activation of said primary translator (103) determines a translation of said at least one first object to be transported (400) along a predefined plane (X-Z).

According to another non-limiting aspect, the method comprises engaging an upper portion (101u) of said supporting element (101) with a lower portion (101i) of said supporting element (101).

According to another non-limiting aspect, the method comprises dragging said head portion (102) in rotation on said rotation axis (Y) by means of said upper portion (101u) of said supporting element (101).

According to another non-limiting aspect, the method comprises engaging said head portion (102) and said upper portion (101u) of said supporting element (101) by means of engaging elements (101n, 102r) in form of rib and corresponding recess, arranged in correspondence of said upper portion (101u) of said supporting element (101) and of said head portion (102) preferably of a base of the head portion (102), configured to be coupled by introduction and to determine the dragging of said head portion (102) in rotation on said rotation axis (Y).

According to another non-limiting aspect, said primary translator (103) comprises at least one between a roller or a conveyor belt, and preferably comprises a plurality of flanked rollers or conveyor belts, preferably flanked along a direction oblique, optionally orthogonal, with respect to said predefined translation direction (X).

According to another non-limiting aspect, said head portion (102) comprises a resting surface (106) for said objects to be transported (400), configured to sustain at least part of the weight of said objects to be transported (400).

According to another non-limiting aspect, said primary translator (103) is substantially aligned to said resting surface (106) or abuts at least partially at a height higher with respect to a height at which said resting surface (106) lies.

According to another non-limiting aspect, said resting surface (106) is substantially planar and/or said primary translator (103) is at least partially arranged in correspondence of a central portion of the resting surface (106).

According to another non-limiting aspect, the activation of said primary translator (103) comprises the activation of at least one roller or a conveyor belt of said primary translator (103) and preferably comprises the activation of a plurality of flanked rollers or conveyor belts of said primary translator (103) preferably flanked along a direction oblique, optionally orthogonal, with respect to said predefined translation direction (X).

According to another non-limiting aspect, arranging at least one first object to be transported (400) in correspondence of at least one transporting device (100) comprises specifically arranging said at least one first object to be transported (400) or said second object to be transported (400) in correspondence of said head portion (102).

According to another non-limiting aspect, the method comprises specifically arranging said at least one first object to be transported (400) or said second object to be transported (400) in correspondence of a resting surface (106) of said head portion (102).

According to another non-limiting aspect, at least one among said rotation actuator (104), said primary translator (103) and said secondary translator (105) is configured to be actuated with a variable speed or acceleration.

According to another non-limiting aspect, said secondary translator (105) comprises a vibrator, configured to determine a translation, optionally cyclic and/or reciprocating with an ascending and descending, of at least one among said primary translator (103) and/or said head portion (102), said at least one first object to be transported (400), optionally said first object to be transported and said second object to be transported (400), along said rotation axis (Y) or along a direction substantially parallel to said rotation axis (Y).

According to another non-limiting aspect, said rotation actuator (104), said primary translator (103) and said secondary translator (105) are independently activatable.

According to another non-limiting aspect, said secondary translator (105) is configured to determine a translation, optionally cyclic and/or reciprocating with an ascending and descending movement, along said rotation axis (Y), or along a direction substantially parallel to said rotation axis (Y), with a variable frequency between a first minimum value and a second maximum value.

According to another non-limiting aspect, said device comprises at least a use configuration wherein said primary translator (103) and said secondary translator (105) are activated in substantial simultaneity.

According to another non-limiting aspect, the activation of said device (100) comprises an adjustment of a speed or of an acceleration of at least one among said rotation actuator (104), said primary translator (103) and said secondary translator (105).

According to another non-limiting aspect, said supporting element (101) comprises said rotation actuator (104), a first actuator for said primary translator (103) and a second actuator for said secondary translator (105).

According to another non-limiting aspect, said rotation actuator (104), said first actuator and said second actuator are electric actuators.

According to another non-limiting aspect, the activation of said transporting device (100) is an electric activation, and comprises an electric activation of at least one among said rotation actuator (104), said primary translator (103) and said secondary translator (105).

In accordance to a further independent aspect is further herein described a transporting system (200), comprising a supporting structure (210) configured to house a plurality of transporting devices (100) according to one or more of the herewith disclosed aspects in a predefined spatial configuration, in such a way to realize a motion surface (201) for said objects to be transported (400),
said transporting system (200) comprising at least one data processing unit (202), operatively connected to said plurality of transporting devices (100) and configured to activate, preferably simultaneously, at least part of said plurality of transporting devices (100) according to a predefined scheme of activation destined to detect a motion path of said objects to be transported (400).

In accordance to a further independent aspect is further herein described a method for moving objects to be transported, comprising:
arranging at least one first object to be transported (400) in correspondence of at least one transporting device (100) of a plurality of transporting devices (100) part of a transporting system (200), wherein said transporting system (200) comprises a supporting structure (210) configured to house said plurality of transporting devices (100) in a predefined spatial configuration, in such a way to realize a motion surface (201) for said objects to be transported (400);
carrying out an activation of at least part of said plurality of transporting devices (100) in order to move said at least one first object to be transported (400), determining a translation of said at least one first object to be transported (400) along said first predefined translation direction (X) and/or a rotation of said at least one first object to be transported (400) with respect to said rotation axis (Y), and/or a translation of said at least one first object to be transported (400) along a direction substantially parallel to said rotation axis (Y),
optionally wherein the transporting device (100) is a device according to one or more of the aspects herein described.

According to another non-limiting aspect, said method comprises separating from, and/or unstacking, a second object to be transported (400) with respect to said first object to be transported (400), wherein said first object to be transported (400) and said second object to be transported (400) are substantially superimposed along a direction substantially parallel to said rotation axis (Y) by means of a substantially cyclic translation, and/or determining a reciprocating ascending and descending movement, along said direction substantially parallel to said rotation axis (Y), by means of a secondary translator (105) of said transporting device (100).

According to another non-limiting aspect, said method comprises putting in a substantially translatory cyclic and/or reciprocating ascending and descending movement along a direction substantially parallel to said rotation axis (Y), said first object to be transported (400) and a second object to be transported (400) at least partially superimposed to said first object to be transported (400) along said direction substantially parallel to said rotation axis (Y), by means of a secondary translator (105) of said transporting device (100).

According to another non-limiting aspect, the transporting system (200) comprises at least one sensor (203) configured to identify a superimposition of at least one first and one second object to be transported (400), respectively lying at said first height (L1) and said second height (L2), said sensor (203) being operatively connected, preferably electrically and/or optically connected, with said data processing unit (202).

According to another non-limiting aspect, said data processing unit (202), when said sensor (203) identifies said superimposition, activates said at least part of said plurality of transporting elements (100) for determining a fall at least of said second object (400) from said second height (L2) to said first height (L1).

According to another non-limiting aspect, the method comprises the activation of a sensor (203) configured to identify a superimposition of at least one first and one second object to be transported (400), respectively lying at said first height (L1) and said second height (L2), said sensor (203) being operatively connected, preferably electrically and/or optically connected, with said data processing unit (202).

According to another non-limiting aspect, said method comprises the identification of said superimposition by means of said sensor (203) and comprises, after said identification, the activation of said at least part of said plurality of transporting elements (100) for determining a fall at least of said second object (400) from said second height (L2) to said first height (L1).

According to another non-limiting aspect, said supporting structure (210) comprises a plurality of seats, optionally a plurality of recesses, each one configured to house a respective supporting element (101) of a respective and single transporting device (100).

According to another non-limiting aspect, at least part of the head portions (102) of the plurality of transporting devices (100) lies on a same plane.

According to another non-limiting aspect, at least part of the head portions (102) is arranged in such a way to define a supporting surface for said at least one first object (400) and/or said second object (400), said supporting surface being reconfigurable in at least one among a planar configuration, optionally orthogonal to said rotation axis (Y), an inclined configuration, optionally inclined and non-orthogonal to said rotation axis (Y), optionally a configuration inclined along a first direction and a second direction not parallel to each other and/or not orthogonal to said rotation axis (Y).

According to another non-limiting aspect, said supporting surface comprises at least one first concave portion and/or at least one first convex portion.

According to another non-limiting aspect, the method comprises arranging a single transporting device (100) in a respective seat of a supporting structure (210), optionally wherein said seat is a recess; said seat being configured to house a respective supporting element (101) of a respective and single transporting device (100).

According to another non-limiting aspect, said supporting structure (210) comprises a substantially planar surface and/or is arranged in a lower position of said supporting element (101), preferably being arranged in a bottom portion of said supporting element (101).

According to another non-limiting aspect, at least part of the seats of said plurality of seats has a substantially circular section, and/or said supporting element (101) and/or said head portion (102) defines a shape having a substantially circular section.

According to another non-limiting aspect, said primary translator (103) is actuated in motion by means of a tape or belt transmission (102x, 102v), preferably wherein said tape or belt transmission (102x, 102v) is put in motion by a first motor (101m), preferably an electric motor, arranged in said supporting element (101).

According to another non-limiting aspect, the method comprises putting in motion said primary translator (103) by means of an actuation of a tape or belt transmission (102x, 102v), preferably wherein said tape or belt transmission (102x, 102v) is put in motion as a result of an activation of a first motor (101m), preferably an electric motor, placed in said supporting element (101).

According to another non-limiting aspect, said tape or belt transmission (102x, 102v) is arranged in said head portion (102).

According to another non-limiting aspect, said first motor (101m) is arranged in correspondence of said lower portion (101i) of said supporting element (101).

According to another non-limiting aspect, said upper portion (101u) is configured to rotate with respect to said lower portion (101i) by an angle greater than 180°, preferably greater than 270°, more preferably greater than 360°, optionally by multiples of at least one of said angles.

According to another non-limiting aspect, said rotation actuator (104) comprises a rotation motor (101n) or second motor, preferably an electric motor.

According to another non-limiting aspect, the activation of said rotation actuator (104) comprises the activation of a rotation motor (101n) or second motor, preferably an electric motor.

According to another non-limiting aspect, said rotation motor (101n) or second motor is located in said supporting element (101), preferably in said lower portion (101i) of said supporting element (101).

According to another non-limiting aspect, said rotation motor (101n) is configured to be activated independently of, and/or simultaneously with, said first motor (101m).

According to another non-limiting aspect, the method provides for activating said rotation motor (101n) or second motor, independently of and/or simultaneously with said first motor (101m).

According to another non-limiting aspect, said transporting system (200) is configured to carry out, by means of said plurality of transporting devices (100), a conveying or transporting function, wherein said plurality of transporting devices (100) is configured to move a plurality of objects to be transported (400) from a plurality of inlet tracks (211) toward a single transporting direction (212), preferably wherein said plurality of inlet tracks (211) comprises at least one first and a second track inclined to each other.

According to another non-limiting aspect, said method comprises activating said transporting system for carrying out by means of said plurality of transporting devices (100), a conveying or transporting function, wherein said plurality of transporting devices (100) is activated and moves a plurality of objects to be transported (400) from a plurality of inlet tracks (211) toward a single transporting direction (212), preferably wherein said plurality of inlet tracks (211) comprises at least one first and a second track inclined to each other.

According to another non-limiting aspect, said transporting system (200) is configured to carry out, by means of said plurality of transporting devices (100), a sorting function, wherein said plurality of transporting devices (100) is configured to move a plurality of objects to be transported (400) from a single inlet track (211) to a plurality of outlet tracks (213), preferably comprising at least one first track and a second track inclined to each other, in such a way that a first sub-part of said plurality of objects to be transported (400) is moved toward a first outlet track of said plurality of outlet tracks (213) and in such a way that a second sub-part of said plurality of objects to be transported (400) is moved toward a second outlet track of said plurality of outlet tracks (213).

According to another non-limiting aspect, said method comprises activating said transporting system (200) for carrying out, by means of said plurality of transporting devices (100), a sorting function, wherein said plurality of transporting devices (100) is activated and moves a plurality of objects to be transported (400) from a single inlet track (211) to a plurality of outlet tracks (213), preferably comprising at least one first track and one second track inclined to each other, in such a way that a first sub-part of said plurality of objects to be transported (400) is moved toward a first outlet track of said plurality of outlet tracks (213) and in such a way that a second sub-part of said plurality of objects to be transported (400) is moved toward a second outlet track of said plurality of outlet tracks (213).

According to another non-limiting aspect, said transporting system (200) is configured to carry out, by means of said plurality of transporting devices (100), a singularization function wherein a plurality of objects to be transported (400) coming from an inlet track (211) is arranged on one or more ordered flows (214) of objects to be transported (400), optionally parallel, on an outlet track (213), preferably wherein every flow of said ordered flows (214) of objects to be transported (400) is independently controllable in speed and/or forward direction by means of at least part of said plurality of transporting devices (100).

According to another non-limiting aspect, said method comprises activating said transporting system (200) for carrying out, by means of said plurality of transporting devices (100), a singularization function wherein a plurality of objects to be transported (400) coming from a inlet track (211) is arranged on one or more ordered flows (214) of objects to be transported (400), optionally parallel, on an outlet track (213), preferably wherein the method comprises controlling each flow of said ordered flows (214) of objects to be transported (400) independently in speed and/or forward direction by means of at least part of said plurality of transporting devices (100).

According to another non-limiting aspect, said transporting system (200) is configured to carry out, by means of said plurality of transporting devices (100), a cross-docking function, wherein a plurality of objects to be transported (400) aligned on a inlet track (211) is moved by means of at least part of said plurality of transporting devices (100) in such a way that a first sub-portion (215) of said plurality of objects to be transported is arranged on a first row and a second sub-portion (216) of said plurality of objects to be transported is arranged on a second row, preferably said first and second row being parallel.

According to another non-limiting aspect, said method comprises activating said transporting system (200) for carrying out, by means of said plurality of transporting devices (100), a cross-docking function, wherein a plurality of objects to be transported (400) aligned on a inlet track (211) is moved by means of at least part of said plurality of transporting devices (100) in such a way that a first sub-portion (215) of said plurality of objects to be transported is arranged on a first row and a second sub-portion (216) of said plurality of objects to be transported is arranged on a second row, preferably said first and second row being parallel.

According to another non-limiting aspect, said transporting system (200) is configured to carry out, by means of said plurality of transporting devices (100), a palletizing function, wherein a plurality of objects to be transported (400), arranged in bulk on a loading track (211) is oriented and/or translated by means of at least part of said plurality of transporting devices (100) for realizing an agglomerate of objects to be transported (400) having a predetermined geometry (216), preferably wherein in said agglomerate said objects to be transported (400) are arranged at least substantial partial contact.

According to another non-limiting aspect, said method comprises activating said transporting system (200) for carrying out, by means of said plurality of transporting devices (100), a palletizing function, comprising orienting and/or translating by means of at least part of said plurality of transporting devices (100) a plurality of objects to be transported (400), originally arranged in bulk on a loading track (211), for realizing an agglomerate of objects to be transported (400) having a predetermined geometry (216), preferably wherein in said agglomerate said objects to be transported (400) are arranged at least substantial partial contact.

According to another non-limiting aspect, said transporting system (200) is configured to carry out, by means of said plurality of transporting devices (100), a de-palletizing function, wherein a plurality of objects to be transported (400), arranged in an agglomerate having a predetermined geometry (216), preferably wherein in said agglomerate said objects to be transported (400) are arranged at least substantial partial contact, are oriented and/or translated by means of at least part of said plurality of transporting devices (100), and are deconglomerated and, preferably, substantially spaced from each other, and/or randomly oriented with respect to each other.

According to another non-limiting aspect, said method comprises activating said transporting system (200) for carrying out, by means of said plurality of transporting devices (100), a de-palletizing function, comprising orienting and/or translating by means of at least part of said plurality of transporting devices (100) a plurality of objects to be transported (400), originally arranged in an agglomerate having a predetermined geometry (216), preferably wherein in said agglomerate said objects to be transported (400) are arranged at least substantial partial contact, for deconglomerate them and, preferably, substantially spaced from each other, and/or randomly oriented with respect to each other.

### FIGURES

The following detailed description relates to some preferred embodiments of the object of the present disclosure. The detailed description makes reference to the attached figures, a short description thereof is provided below.

FIG. 1 shows a transporting system of a known type, with aggregate wheels.

FIG. 2 shows a lateral view of a transporting device, object of the present disclosure. The transporting device is represented inserted in a transporting system, and is overlaid by a first object to be transported and by a second object to be transported. The second object to be transported is stacked on the first object to be transported.

FIG. 3 shows a lateral view of the transporting device object of the present disclosure. The transporting device is represented inserted in the transporting system. With respect to FIG. 2, the first and the second object to be transported are no longer stacked; the second object to be transported has been unstacked by the first because of a technical functionality of the transporting device.

FIG. 4 shows a perspective view of a preferred embodiment of the transporting device object of the present disclosure.

FIG. 5 shows a first configuration of the transporting device and a second configuration of the transporting device, wherein the head portion is rotated by an angle ϕ.

FIG. 6 shows a perspective view of a preferred embodiment of the transporting device object of the present disclosure. In FIG. 6, the head portion of the transporting device is devoid of a part of the lateral wall, in order to allow to see the elements present in the central portion of the head portion.

FIG. 7 shows a perspective view similar to the one of FIG. 6, but where the upper portion of the transporting device is devoid of a further part.

FIG. 8 shows a cross-section perspective view of the lower element of the transporting device object of the present disclosure.

FIG. 9 shows a cross-section view of a translator that is installed on the head portion of the transporting device.

FIG. 10 shows a top view of a first and a second transporting device object of the present disclosure, whose respective translators are destined to move an object to be transported along a first direction and along a second direction different with respect to the first one.

FIG. 11 shows a top view of a non-limiting embodiment of a transporting system that comprises a plurality of transporting devices object of the present disclosure.

FIG. 12 shows a top view of a non-limiting embodiment of a transporting system object of the present disclosure, carrying out a sorting function.

FIG. 13 shows a top view of a non-limiting embodiment of a transporting system object of the present disclosure, carrying out a singularization function.

FIG. 14 shows a top view of a non-limiting embodiment of a transporting system object of the present disclosure carrying out a cross-docking function.

FIG. 15 shows a top view of a non-limiting embodiment of a transporting system object of the present disclosure carrying out a palletizing function.

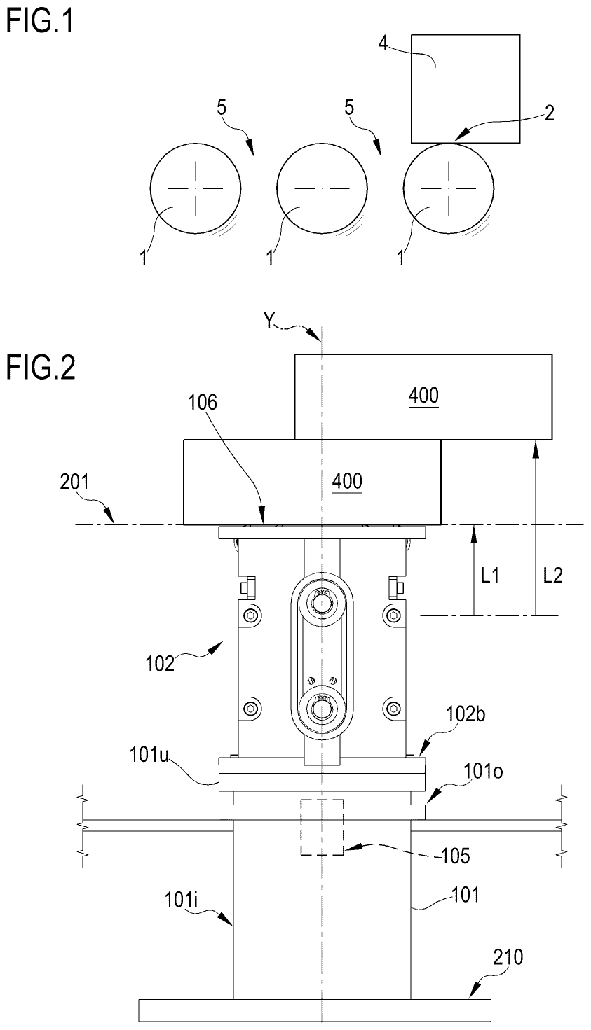

### DETAILED DESCRIPTION

Reference is made to FIGS. 2, 3 and 4. With the numerical reference 100 is indicated as a whole a transporting device. The transporting device 100 is mainly destined to move one or more objects to be transported, indicated with the numerical reference 400.

These objects to be transported can be objects of any typology or shape, and for this reason the box shape schematically indicated in the attached figures is not to be intended as limiting.

The transporting device 100 is preferably comprising two main parts. These parts are a supporting element 101 and a head portion 102.

The supporting element 101 is configured to be fixed, in particular in a fixed and predetermined position, on a supporting structure indicated by the numerical reference 210. In particular, the supporting structure 210 can be a supporting surface that lies in correspondence of the lower portion, in particular of the bottom portion, of the supporting element.

Preferably, the head portion 102 is removably installed on the supporting element 101 and is arranged at a height typically higher with respect to the height at which lies the supporting element 101.

The head portion 102 comprises a primary translator identified by the numerical reference 103. The primary translator 103 is destined to translate the objects to be transported 400 along at least one first predefined translation direction X.

The head portion in particular detects a resting surface 106 for the object to be transported 400, that is preferably of planar type. In this case the predefined translation direction X is aligned on the plane detected by the resting surface 106.

This plane is also defined by a second direction Z, orthogonal to the predefined translation direction X.

A third direction is detected by an axis Y, orthogonal to the predefined translation direction X and to the second direction Z.

The transporting device 100 object of the present disclosure also comprises a rotation actuator 104 that is configured to rotate the head portion 102 with respect to the supporting element 101 along the rotation axis Y.

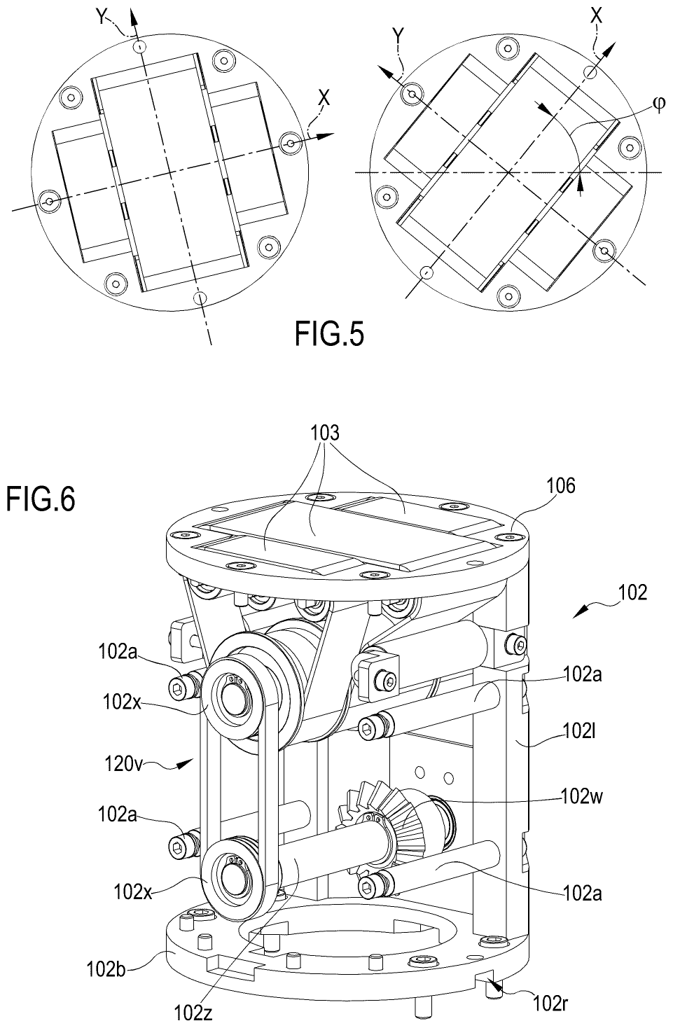

As clearly shown in FIG. 5, the primary translator 103 is integral in rotation on the axis Y with the head portion 102: the rotation of the head portion 102 by an angle ϕ on the axis Y with respect to the supporting element 101 determines a corresponding rotation of the primary translator 103 with respect to the supporting element 101 by a same angle ϕ.

Although in the herein shown figures the rotation axis Y is orthogonal with respect to the predefined translation direction X, this condition is not to be intended in a limiting way. In fact, further embodiments of the transporting device 100 object of the present disclosure can comprise a rotation axis Y that is not orthogonal, but oriented in a generic direction oblique with respect to the predefined translation direction X.

The transporting device 100 object of the present disclosure is configured to singularize at least one first and one second object to be transported 400 at least partially superimposed and respectively arranged at a first height L1 and at a second height L2, at least partially arranged in correspondence of said head portion 102, determining a fall of the second object to be transported 400 from said second height L2 to said first height L1.

The first and the second height L1, L2 are measured for example on the base of the object to be transported or on a further reference height. Conveniently the first height L1 is the height at which the supporting surface 106 of the head portion 102 lies, and/or is the height at which the primary translator 103 lies.

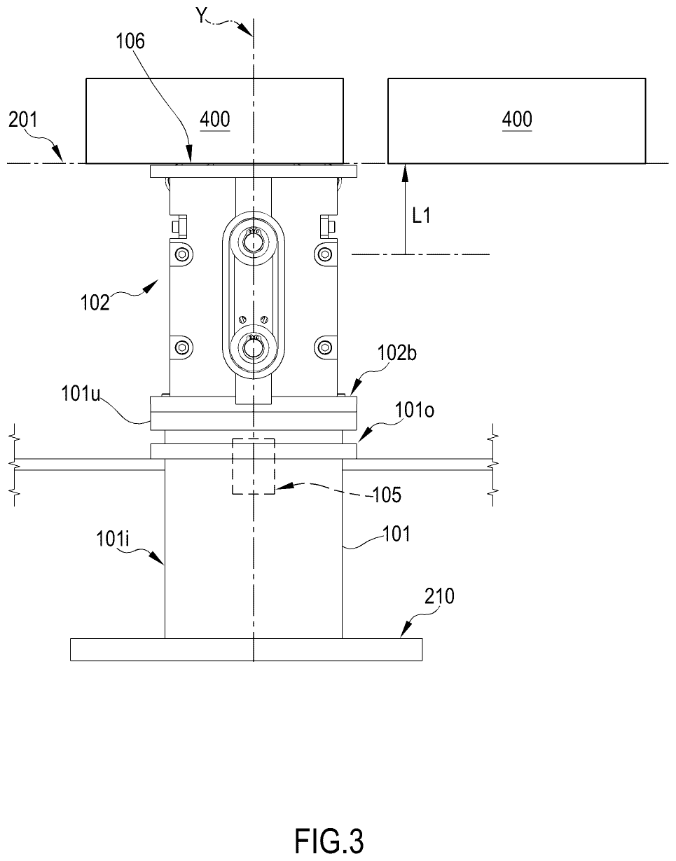

In FIG. 2 and in FIG. 3, the first height L1 and the second height L2 are measured from a reference point positioned below the maximum height reached by the head portion 102 (in correspondence of the supporting surface 106).

In use, when at least one first object to be transported 400 is arranged in correspondence of the transporting device 100, this transporting device 100 is activated (as will be seen below, electronically) in order to move the at least one first object to be transported 400.

This determines a translation of the object to be transported 400 along the first predefined translation direction X and/or a rotation of the object to be transported 400 with respect to the rotation axis Y (in particular, around or on the rotation axis Y), and/or translation of the first object to be transported 400 along a direction substantially parallel to said rotation axis Y.

When a first and a second object to be transported 400 are arranged in correspondence of the transporting device 100, both the first and the second object to be transported 400 can be translated and/or rotated in the above-described modes.

If the second object to be transported 400 is arranged above the first object to be transported 400, it is clear that this second object to be transported 400 lies at a second height L2 higher with respect to a first height L1 at which lies the first object to be transported L1.

In order to realize the singularization (in particular, in terms of the height) of the first and second object to be transported 400, the activation of the transporting device 100, determines a fall of said second object to be transported 400 from the second height L2 to the first height L1.

In an embodiment, that is clearly non-limiting, the device translator 100 object of the present disclosure comprises also a secondary translator 105 configured to cause a translation of at least one part of the head portion 102, preferably at least said primary translator 103, along a direction substantially parallel to the rotation axis Y with respect to said supporting element 101. In use, when the device translator 100 is appropriately fixed to the supporting structure 210, this rotation axis Y is substantially vertical.

In a non-limiting embodiment, the secondary translator 105 is a vibrator, capable of making the head portion 102 perform a substantially vibratory (reciprocating) movement along the rotation axis Y. The movement induced by the secondary translator 105 is a specifically reciprocating, therefore cyclic, ascending and descending movement along a direction detected by the rotation axis Y (then, a substantially vertical direction). The translation of the head portion 102 with respect to the supporting element 101 induces a corresponding translation of the first and second object to be transported along the same direction.

In a non-limiting embodiment, movement secondary translator 105 in form of a vibrator, is configured to determine a vertical movement of the head portion for a stroke equal to or lower than 1 mm, or equal to or lower than 2 mm or equal to or lower than 5 mm or equal to or lower than 1 cm.

For example, the vibration frequency of the vibrator can be equal to or lower than 1 Hz, or equal to or lower than 5 Hz or equal to or lower than 10 Hz or equal to or lower than 15 Hz, or higher than 1 Hz, or higher than 5 Hz, or higher than 10 Hz or higher than 15 Hz.

In a particular embodiment, the secondary translator 105 is configured to make the head portion 102 carry out a substantially vibratory (reciprocating) movement along the rotation axis Y with a frequency variable over time, in particular variable between a first minimum value and a second maximum value. The law with which the variation of frequency over time is carried out can be a linear law or a non-linear law.

At least one among the first minimum value and the second maximum value can be set in the factory, and fixed, or can be set by the user, and in particular altered with respect to a default value set in the factory.

In other words, the translator 105 is configured to operate a motion of the head portion 102 with a frequency modulation.

The Applicant has noted that varying the frequency of the reciprocating movement of the head portion 102 can promote the de-stacking of objects.

A particular use configuration is such that the frequency modulation in the translation of the head portion 102 along the rotation axis Y can occur simultaneously to the translation along the first predefined translation direction X.

The frequency modulation of the reciprocating movement of the head portion 102 can be activated by default or, alternatively, be used as an auxiliary measure where the de-stacking without frequency modulation is not successful.

Conveniently the secondary translator 105 can comprise a mechanical servo-actuator with an eccentric cam, or a piezo.

The transporting device 100 is configured to singularize the objects to be transported 400 by means of at least one among an activation of the rotation actuator 104, an activation of the primary translator 103, an activation of the secondary translator 105. Therefore, in a preferred embodiment, the three above-mentioned elements, i.e. the rotation actuator 104, the primary translator 103 and the secondary translator 105, are activatable independently of each other, and in particular the primary translator 103 can be activated independently with respect to the rotation actuator 104.

Preferably, this occurs by means of a composite and simultaneous, and/or sequential, movement of rotation of the head portion 102 on the rotation axis Y and of translation along the predefined translation direction X determined by the simultaneous, and/or sequential, activation, of the rotation actuator 104 and of the primary translator 103, or by means of a composite and simultaneous, and/or sequential, movement of rotation of the head portion 102 on the rotation axis Y and of translation along the rotation axis Y determined by the simultaneous, and/or sequential, activation, of the rotation actuator 104 and of the secondary translator 105, or by means of a composite and simultaneous movement, or in sequence, of translation along the predefined translation direction X and along the rotation axis Y determined by the simultaneous, and/or sequential, activation, of the primary translator 103 and of the secondary translator 105.

In use, therefore, the activation of the transporting device 100 comprises an activation of a secondary translator 105 configured to cause a translation of at least one part of the head portion 102, preferably at least said primary translator 103, along a direction substantially parallel to the rotation axis Y with respect to the supporting element 101.

The activation of the transporting device 100 comprises at least one among an activation of the rotation actuator 104, an activation of the primary translator 103, an activation of the secondary translator 105. The activation of the secondary translator can be such as to determine a vibration of the object or of the objects to be transported along the rotation axis Y.

As clearly visible in the attached figures, the primary translator 103 comprises three small conveyor belts that are arranged flanked and that slide along parallel directions, in turn parallel and defining the first predefined translation direction X.

The three conveyor belts are aligned along a direction orthogonal with respect to the predefined translation direction X.

The three conveyor belts are so configured:
a first conveyor belt is arranged in the central portion of the resting surface 106 of the head portion 102 and has a first linear extension;
a second and a third conveyor belt are arranged on the two opposite sides of the first conveyor belt, and are arranged in a lateral portion of the resting surface 106 of the head portion 102, and have a second linear extension.

The transversal linear extension of the second and third conveyor belt is lower with respect to the transversal linear extension of the first conveyor belt.

The conveyor belts are preferably realized by a single closed ring element, flexible and preferably elastic. Conveniently the primary translator 103 is realized in a material with a high friction coefficient, for example in silicone or rubber or another type of polymeric material.

The presence of three conveyor belts should not be considered neither necessary nor limiting. In fact, the primary translator 103 can comprise at least one between a roller or a conveyor belt, and preferably comprises a plurality of flanked rollers or conveyor belts. Preferably, they are flanked along a direction oblique, optionally orthogonal, with respect to the predefined translation direction X. Conveyor belts are substantially flat belts.

In case it is present only one conveyor belt or roller, conveniently this conveyor belt or roller will be arranged in the central portion of the resting surface 106, in such a way to be surrounded by a substantially free edge of the resting surface 106.

As clearly visible in the attached figures, in a preferred embodiment the head portion 102 comprises a resting surface 106 for the objects to be transported 400 of substantially planar type. This resting surface 106 is configured to sustain at least part of the weight of the objects to be transported 400.

The primary translator 103 is substantially aligned to the resting surface 106 or abuts at least partially at a height higher with respect to a height at which the resting surface 106 lies. This ensures sufficient sliding friction force with the object to be transported 400 to allow a quick movement, and preferably a quick acceleration in translation and/or rotation of the object to be transported 400.

The primary translator 103 can have the function of primary friction element configured to retain the object to be transported 400. In other terms, the adherence offered by the primary translator 103 on the object to be transported 400 is higher with respect to the adherence offered by the resting surface 106. Also when the head portion 102 is put in rotation by a predetermined angle ϕ, conveniently it is the primary translator 103 to ensure that as far as possible the object to be transported 400 integrally rotates with the head by the above-mentioned predetermined angle ϕ.

In use, the activation of the primary translator 103 determines putting in motion, in particular a rotation, at least one roller or a conveyor belt of said primary translator that allows to translate and/or rotate the object to be transported.

The previously mentioned singularization in vertical direction can in particular occur by means of a vibratory characteristic induced by the secondary translator 105. In a non-limiting embodiment the secondary translator can determine a reciprocating movement along the rotation axis Y of the resting surface 106 and of the primary translator 103 with a progressive acceleration and deceleration in two opposite directions along the rotation axis Y.

Also this singularization in vertical direction can occur since the primary translator 103 and the secondary translator 105 are configured to be actuated with a variable speed and more preferably with a variable acceleration.

The supporting element 101 object of the present disclosure comprises the rotation actuator 104, a first actuator for the primary translator 103 and a second actuator for the secondary translator 105. In a preferred but non-limiting embodiment, at least one and preferably all the above-described actuators are of electric type.

The above-described actuators can for example comprise an electric motor of the stepper type, or synchronous motors with permanent magnets.

In a non-limiting embodiment, these motors can be motors of brushless type, and in particular be multipolar motors.

Generally, the rotation properties (angle, speed, acceleration, of rotation) of the motors of the device object of the present disclosure should be precisely controllable; this technical characteristic is useful when it is necessary to move objects 400 with a very limited and precise linear or rotating movement.

It is also important that the electric motor is small in size, so it can be easily installed inside the supporting element 101.

Electric motors of brushless type have high dynamic characteristics and are also provided with constant torque up to maximum speed.

It is also preferable that the electric motor is controllable in such a way to have very high accelerations, and this can be convenient to facilitate the singularization in vertical direction, so as to carry a first and a second object to be transported 400 originally stacked, to the first height L1.

Previously, it has been described that the supporting element 101 is removably constrained to the head portion 102, which overlies it in a direction aligned with the rotation axis Y.

Conveniently the rotation actuator 104, the first actuator and the second actuator are positioned inside the supporting element 101 and conveniently transfer the motion necessary for the rotation of the roller or of the conveyor belt, and for the rotation of the head portion 102 by means of motion transfer mechanisms comprising a belt transmission with a double pulley, or a bevel gear.

Having a head portion 102 without actuators is advantageous. In fact, in this way, the head portion 102 is cost-effective to produce, and when damaged can be replaced by means of the disconnection with the supporting element 101 without resulting in a significant cost.

Furthermore, having a head portion 102 without actuators allows to maintain the head portion light. The lightness of the head portion 102 is useful for being able to be accelerated in translation or rotation with respect to the axis Y with easiness, without large inertias that would determine the use of proportionally more powerful electric motors.

In a preferred but non-limiting embodiment, the head portion 102 can be produced by means of a molding process, for example injection molding or co-molding.

The supporting element 101 conveniently can comprise a connector 101h configured to provide electrical power to the rotation actuator 104, to the first actuator and to the second actuator.

The head portion 102 is without a wired connection with the supporting element 101. This mechanical configuration advantageously allows a rotation of the head portion 102 with respect to the supporting element 101 by more than 360°, then on a virtually indefinite multiplicity of rotation cycles. This provides a particular control flexibility, which is conversely limited if there is a wired connection between the head portion and the supporting element of known transporting devices.

In light of the above-described technical characteristic, it is clear that the head portion 102 can rotate with respect to the supporting element 101 by an angle higher than 180°, or higher than 270°, or higher than 360° or multiples thereof.

Furthermore, advantageously, it is possible to adapt the size of the head portion 102 with respect to the size of the supporting element 101, without the need to make changes to the latter as well.

The transporting device 100 object of the present disclosure can advantageously comprise a weight sensor, configured to reveal if on the head portion 102 weighs the weight of any object or not. The weight sensor is of the electronic type.

The head portion 102 comprises also a lower ring 102b which is configured to be directly coupled with the supporting element 101. The lower ring 102b comprises a plurality of engaging pins on the supporting element 101. Alternatively these engaging pins can be equivalently replaced by holes in correspondence thereof is arranged a respective pin of the supporting element 101.

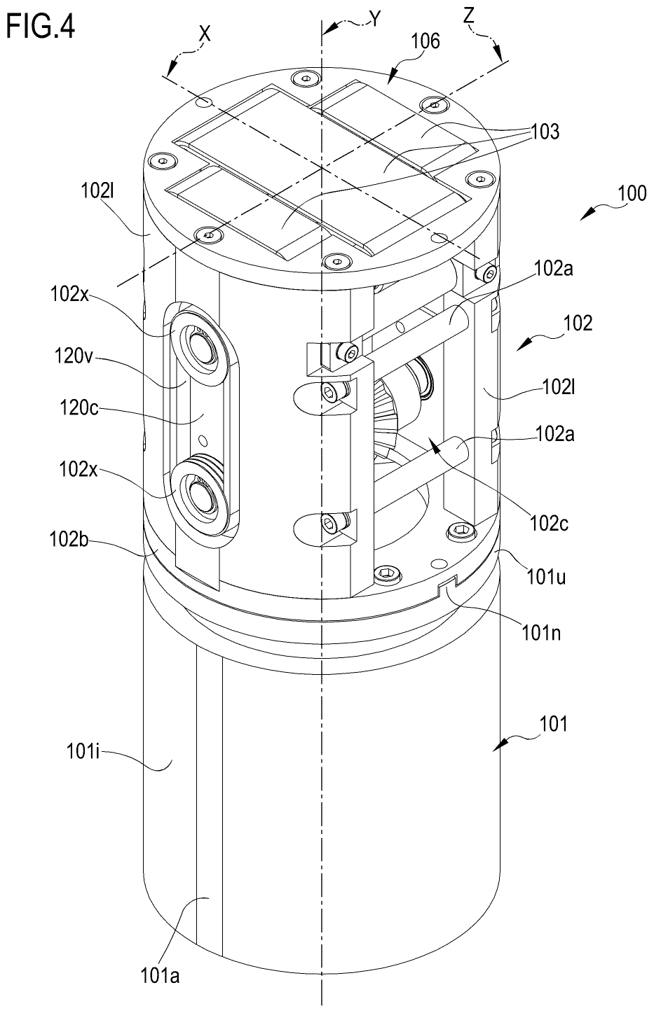

As represented in FIG. 4, and more in detail in the perspective section of FIG. 8, the supporting element 101 comprises a lower portion and an upper portion, respectively indicated with numerical references 101i and 101u.

The lower ring 102b is in particular fixed to the supporting element 101 in correspondence of the upper portion 101u thereof, and is integral in rotation on the axis Y with the upper portion 101u.

The lower portion 101i is configured to be rest on a supporting surface 210 of a transporting system 200 that will be better described below.

In a preferred but non-limiting embodiment, the upper portion 101u of the supporting element 101 comprises a substantially planar upper surface and provided with ribs 101n for the engagement on the head portion 102. The embodiment shown in the attached figures is such that the upper surface of the supporting element 101 comprises at least two opposed ribs 101n.

The supporting element 101 can be configured to be operatively released from the head portion 102 by means of a tool. In an embodiment, in correspondence of the ribs 101n can be present holes axially aligned with the axis Y, for the engagement of a tool with an elongated body shape that is configured to pass through a service hole of the head portion 102.

In a preferred embodiment, the whole device (supporting element 101, head portion 102) is releasable by the supporting surface 210, so that in case of mechanical and/or electronic failure it is possible to replace the entire device and then proceed, only at a second stage, with the separation of the head portion 102 from the supporting element 101.

It is then clear that the present disclosure shows a device wherein the head portion 102 and the supporting element 101 are operatively releasable by means of a tool. This technical characteristic advantageously allows to speed up the possible removal of head portions 102 that must be replaced, for example because they are broken, in such a way to reduce the downtime of the transporting system.

The upper portion 101u of the supporting element 101 further comprises a lateral surface. In the embodiment shown in the attached figures, the lateral surface extends in a direction substantially orthogonal with respect to the upper surface.

The ribs 101z are in use introduced in recesses 102r present in correspondence of a base of the head portion 102.

The upper portion 101u is configured to rotate with respect to the lower portion 101i. In particular, the relative rotation that can take place between these two portions occurs on the axis Y.

The lower portion 101i is fixed in correspondence of the respective seat or recess in such a way to not be able to rotate on the axis Y. Consequently, with the rotation of the upper portion 101u with respect to the lower portion 101i, because of the engagement that is present among the ribs 101n and the recesses 102r, the head portion 102 is dragged into rotation around the axis Y, and rotates with respect to the lower portion 101i of the supporting element 101.

The lower portion 101i comprises a supporting ring 101o that is configured to be positioned in correspondence of an intermediate plane, preferably parallel to the support plane 210. The supporting ring 101o departs from the lateral surface of the lower portion 101i of the supporting element 101 along a direction substantially inclined, preferably substantially orthogonal with respect to the lateral surface.

In an embodiment that is not to be intended as limiting, the supporting ring 101o is preferably arranged in correspondence of an area of the lower portion 101i next to the upper portion 101u.

Clearly, the above-described configuration is not to be intended in a limiting way. For example, the recesses could be realized on the upper surface of the upper portion 101u of the supporting element 101, and the ribs could be realized on the base of the head portion 102.

In light of the above, it is therefore clear that the present disclosure discloses the presence of engaging elements 101n, 102r in form of rib and corresponding recess, generally arranged on the upper portion of the supporting element 101 and on the head portion 102. In particular, these engaging elements 101n, 102r are arranged on the upper portion 101u of the supporting element 101 and on the base of the head portion 102.

For example, ribs 101n or recesses 102r could be arranged on the lateral surface of the upper portion 101u of the supporting element 101.

On the upper surface of the upper portion of the supporting element 101 is present a portion of a first gear 101k of a bevel gear 101w-102w. The first gear 101k rotates on the axis Y and is positioned in a centered position on the upper surface.

The upper portion of the supporting element 101 comprises a support 101p for a position sensor; the support 101p overlays at least partially the first gear 101k.

As represented in the perspectives of FIGS. 4, 6 and 7, the head portion 102 has a cavity opening at least in correspondence of one of its bottom areas; this cavity 102c allows the partial introduction of the first gear 101k inside the volume overall detected by the head portion 102.

The second gear 102w of the bevel gear 101k-102w is rotatably fixed on a lateral wall of the head portion 102. The second gear 102w abuts from an inner face of the lateral wall of the head portion 102. The inner face faces the cavity 102c.

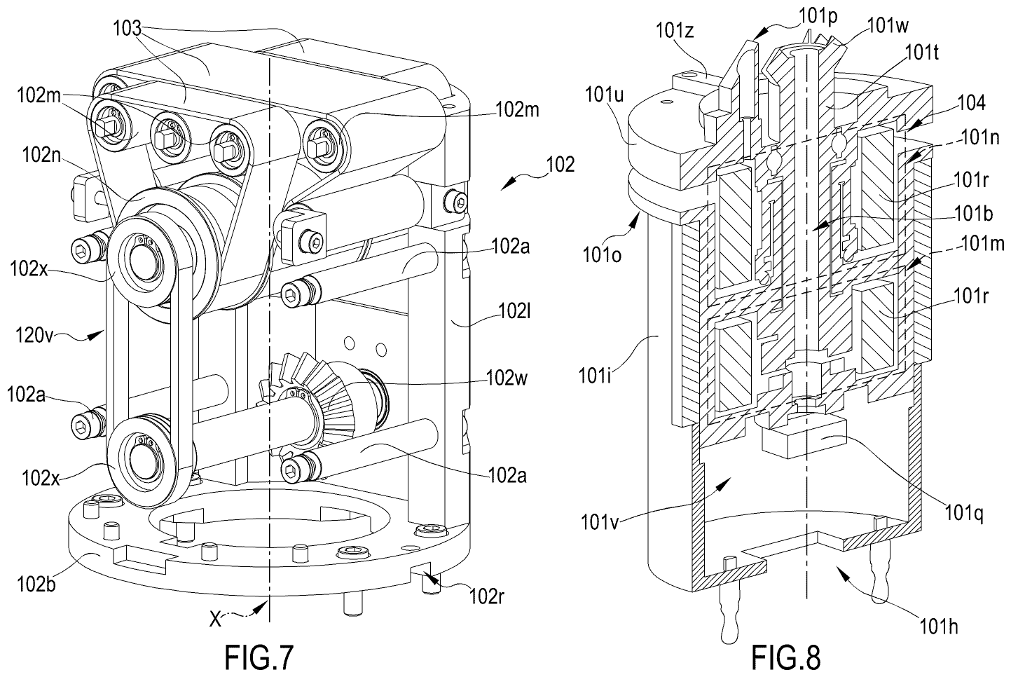

As it is possible to observe, for example from FIG. 7, the lower ring 102b comprises a central hole—preferably of circular shape. This central hole allows the introduction of the first gear 101k of a bevel gear 101k-102w.

The second gear 102w of the bevel gear 101k-102w rotates around an axis significantly orthogonal to the axis Y.

The second gear 102w is connected to a transmission shaft 102z, which is oriented in a substantially horizontal direction and therefore in a direction substantially orthogonal to the axis on which it rotates the head portion 102.

The transmission shaft 102z is connected to the second gear 102w in a rotatably fixed way, and integrally rotates with the second gear 102w.

A first end of the transmission shaft 102z is connected to the second gear 102w; a second end of the transmission shaft 102z, opposed to the first, is connected to a first sheave 102x.

In the embodiment shown in the attached figures, that is non-limiting, the first sheave 102z is accessible from the lateral wall 102l of the head portion 102, and is built-in a lateral recess 120c of the lateral wall 102l of the head portion 102.

The lateral wall 102l has a first portion and a second portion; the first and the second portion are separable, and in particular are separated to leave access to the cavity.

Spacing elements 102a are interposed between the first portion of lateral wall and the second portion of lateral wall. The spacing elements 102a are substantially rigid and arranged along an oblique direction, preferably orthogonal, with respect to the direction detected by the axis Y.

In the embodiment represented in the attached figures, the first portion of lateral wall and the second portion of lateral wall have substantially arcuate shape.

In the embodiment represented in the attached figures, the spacing elements 102a are in cylindrical bar shape.

A belt 102v or an equivalent flexible motion transmission element, transmits a motion to a second sheave 102x that is built-in too in the lateral recess 120c.

The assembly formed by the first sheave 102x, by the second sheave 102x and by the belt 102v realizes a tape or belt transmission.

The second sheave 102x rotates around an axis that is horizontal too. In a preferred embodiment, the second sheave 102x has a diameter identical to that of the first sheave 102x, in such a way to realize a 1:1 transmission ratio. Such technical characteristic is non-limiting.

The second sheave 102x results therefore to be a driven pulley, whereas the first sheave 102x results to be a driving pulley.

An auxiliary pulley 102n rotates integrally with the second sheave 102x. The auxiliary pulley 102n is a sheave too. In the embodiment shown in the attached figures, the primary translator 103, in the form of a flat belt, is introduced into the auxiliary pulley 102n.

Since the embodiment shown in the attached figures has three primary translators 103, there are three auxiliary pulleys 102n all rotating around a significantly horizontal rotation axis.

An alternative embodiment of the device object of the present disclosure comprises a head portion 102 provided with five primary translators 103.

The head portion comprises also a plurality of supports 102m for the primary translators 103. In a non-limiting embodiment, these supports 102m are in the form of rolling elements, in particular are rollers. The supports 102m provide a resting surface for the part of the tapes that faces the supporting surface 106 and reduce the deformation of the belts even under heavy weights.

The supports 102m substantially extend on a plane parallel to the X-Z plane. Preferably, the rolling elements, in particular the rollers, are arranged with the respective rotation axes significantly inclined, preferably orthogonal, with respect to the axis Y.

In the embodiment represented in the attached figures, the axis of the rollers is parallel to the transmission shaft 102z.

Part of the rollers, and more generally of supports 102m can also fulfill the function of tensioning element for the primary translators 103.

The first gear 101w is keyed on a motion transmission shaft 101b which extends between the upper portion and the lower portion 101i of the supporting element 101. In particular, the motion transmission shaft 101b is centered in the supporting element 101, and more in particular is centered on the upper portion and on the lower portion 101i of the supporting element 101.

A rotor group 101r of a first electric motor 101m is fixed to the motion transmission shaft 101b.

The motion transmission shaft 101b is sleeved in a supporting structure 101s of the supporting element 101.

A rotor group 101t of a second electric motor 101n is fixed to the upper portion of the supporting element 101 and drags in jointed rotation the upper portion of the supporting element 101.

The second electric motor 101n is part of the previously described rotation actuator 104. Clearly, the second electric motor 101n is independently activatable from first electric motor 101m. The first and the second electric motor 101m, 101n are simultaneously activatable.

The rotor group 101t of the second electric motor 101n is at a higher height (above) than the height at which it is placed the rotor group 101t of the first electric motor 101m.

The first electric motor 101m and the second electric motor 101n are substantially coaxial and are preferably but non-limiting thereto, torque motors.

Torque motors are direct driving motors: the rotor is directly connected to the load without intermediate elements. This technical feature provides compactness, rigidity and high positioning accuracy, thanks to the absence of backlash especially in direction changes.

The above-described features, in particular relating to the type of electric motors and the structural configuration of the motion transmission elements, provide a reduction of the coupling inertia and a high positioning accuracy.

The lower portion 101i of the supporting element 101 comprises a lateral wall that detects preferably a cylindrical body.

The lateral wall comprises at least one engaging element 101a with seat or recess for the supporting element 101. In the attached figures the engaging element 101a is a rib that extends in direction substantially parallel to the axis Y. The rib introduces itself by sliding in a respective recess realized in correspondence of the seat or recess.

Also in this case, the opposed situation can be alternatively present. The engaging element 101a with the seat or recess for the supporting element 101 can be a recess, for example aligned along a direction substantially parallel to the one of the axis Y, and the rib can be arranged in correspondence of the seat or recess for the supporting element 101.

A base zone of the lower portion 101i can advantageously comprise a hole for the passage of electrical connection cables and a compartment 101v for example for housing sensors.

In a preferred but non-limiting embodiment, a feedback sensor 101q is coupled to the motion transmission shaft 101b. In an embodiment, the feedback sensor 101q is a magnetic sensor, for example a Hall effect sensor.

A magnet of the feedback sensor 101q is fixed in rotation with the motion transmission shaft 101b. In accordance to the relative position between the magnet of the sensor (relative rotation) and a strip sensitive element, it is possible to determine with accuracy the rotation angle of the magnet and then of the motion transmission shaft 101b with respect to a reference angular position.

The feedback sensor 101q is operatively—preferably electrically and/or optically—connected with the data processing unit that will be better described below. The feedback sensor 101q sends back to the data processing unit a signal proportional to the rotation of the motion transmission shaft 101a. This signal can be advantageously used to retroactively correct the movement of the rotor of the first electric motor 101m.

The transporting device 100 is configured to be integrated in a transporting system 200.

The system comprises a supporting structure 210 configured to house a plurality of transporting devices 100 in a predefined spatial configuration, in such a way to realize a motion surface 201 for the objects to be transported 400.

In a preferred but non-limiting embodiment, the transporting devices 100 of the said plurality are all of the same size. In particular, the head portions 102 thereof are all of the same size or type.

Alternatively, in a further embodiment, part of the plurality of transporting devices 100 can have a first dimension (in particular regarding the head portion 102) and a further part of the plurality of transporting devices 100 can have a second dimension (in particular regarding the head portion 102). The second dimension is different from the first dimension.

In a non-limiting embodiment, the motion surface 201 is of planar type and defines therefore a motion plane. This motion plane is parallel to the plane X-Z.

The predefined spatial configuration of the plurality of transporting devices 100 is fixed. These transporting devices can conveniently be located in a matrix configuration of rows and columns substantially orthogonal to each other or in a honeycomb configuration or similar.

The transporting system 200 comprises a data processing unit 202. This data processing unit 202 can comprise a processor of the general-purpose type on which is executed in use a software program that comprises portions of code written in any programming language.

Alternatively or in combination with the processor of the general-purpose type, the data processing unit 202 can comprise a dedicated processor, for example an ASIC, and/or an FPGA and/or a programmable logic controller (PLC).

The data processing unit 202 can integrate, or be operatively (electrically and/or optically) connected with an electronic memory.

To the data processing unit 202 is operatively connected a user interface. The user interface is advantageously of local and/or remote type.

The data processing unit 202 is operatively connected with the whole plurality of transporting devices 100 by means of an at least partially wired connection. This operative connection allows the control of the rotation actuator 104, of the first actuator and of the second actuator.

The data processing unit 202 is configured to activate, preferably simultaneously, at least part of said plurality of transporting devices 100 according to a predefined scheme of activation destined to detect a motion path of said objects to be transported 400.

In an embodiment, the transporting system 200 object of the present disclosure comprises at least one sensor 203 configured to identify a superimposition of at least one first and one second object to be transported 400, respectively lying at said first height L1 and said second height L2.

The sensor 203, preferably a sensor of the optical type, is operatively connected—preferably electrically and/or optically connected—with the data processing unit 202.

In use, when the sensor 203 identifies the superimposition, sends an appropriate alarm signal to the data processing unit 202 which activates at least part of the plurality of transporting elements 100 for determining a fall at least of said second object 400 from the second height L2 to the first height L1.

Preferably, the part of the plurality of transporting elements 100 activated is the one in correspondence thereof weighs the weight of the first and second object to be transported 400.

The motion path can be of linear type and/or comprise curvilinear portions. Conveniently the motion path is defined in relation to coordinates—measured on the above-mentioned matrix—in correspondence thereof there is a multiplicity of transporting devices 100 part of said plurality.

In the embodiment shown in the attached figures, the supporting element 101 and the head portion 102 have a shape that detects a substantially circular section. Thanks to this technical characteristic it is possible to introduce the supporting element 101 and the head portion 102 in a seat or recess of substantially circular shape. In particular, this technical characteristic ensures that it is possible to introduce and allow to rotate the head portion 102 in a seat or recess, even a very deep one, of equal (circular) section leaving a minimum free space between the supporting surface 106 of the head portion 102 and the free edge of the recess. This allows to realize a supporting surface for the objects to be transported 400 that extends substantially uninterruptedly.

Otherwise, if the head portion 102 were of a shape with a non-circular section, in order for it to rotate appropriately in a recess that encloses it, it would have to be of a substantially lower size with respect to the recess itself, and between the shape overall detected by the head portion 102 and the profile of the recess it would be detected a free space of significant size, that would not allow to realize the above-mentioned absence of interruption in the supporting surface overall detected for the objects to be transported 400.

In order to change the direction of the objects to be transported 400, the most used method is to orientate the transporting device 100 rotating the head portion 102 in direction oblique with respect to a head portion 102 of a proximal transporting device. This technical solution is schematically represented in FIG. 10, wherein it is visible the presence of a first transporting device 100 and of a second transporting device 100′, wherein the head portion 102 of the first transporting device has a primary translator 103 oriented so as to direct an object to be transported 400 along a first direction A and wherein the head portion 102 of the second transporting device has a primary translator 103 oriented so as to direct the object to be transported 400 along a second direction B, oblique with respect to the first direction A.

This causes a lateral impact of the object to be transported 400 on the outermost primary translator 103, creating a stress on the latter. This stress determines a wear that can cause breakages due to fatigue.

A particular embodiment of the primary translator 103 is such to reduce the above-described stress, and determine a reduction in downtime and assistance time, of the transporting device 100 object of the present disclosure and, therefore, capable of determining an increase in MTBF of the transporting device 100.

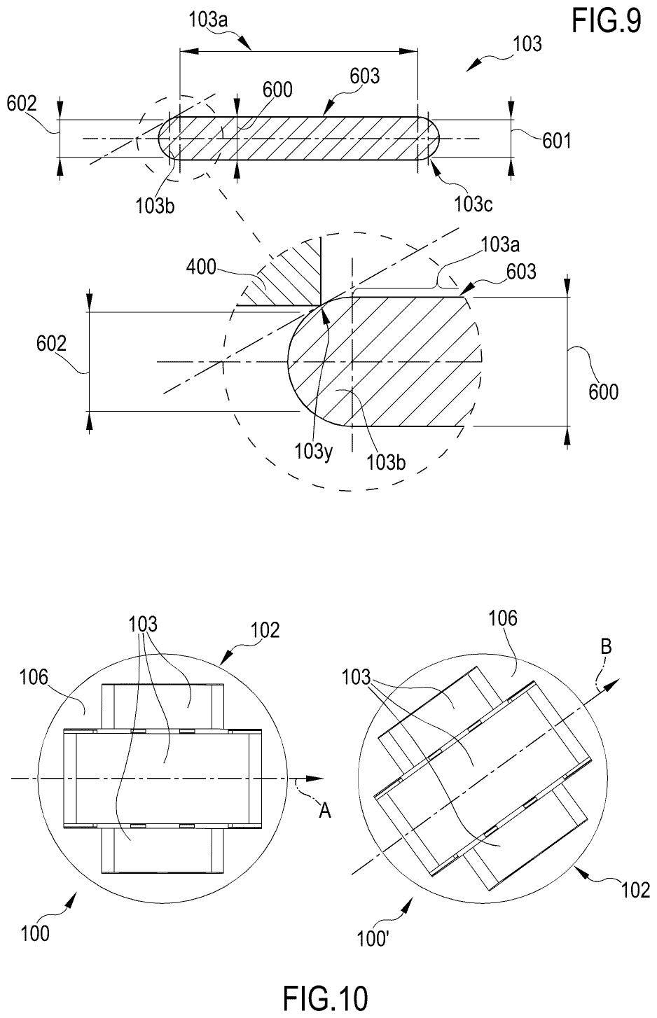

FIG. 9 shows a particular embodiment wherein the primary translator 103 has a rounded shape configured to reduce the mechanical stresses deriving from the impact with an object to be transported 400, in particular configured to reduce the mechanical stresses deriving from the impact of an object to be transported 400 that comes from a motion direction inclined with respect to the motion direction imposed by the primary translator 103 itself.

Observed in cross-section, the primary translator 103, in particular the conveyor belt, comprises:
a central portion 103a;
a first lateral portion 103b and a second lateral portion 103c, the second lateral portion 103c being opposed with respect to the first lateral portion 103b.

The first lateral portion 103b and the second lateral portion 103c are peripheral portions. The central portion 103a detects a support plane 603.

The central portion 103a has a first thickness 600. The first lateral portion 103b and the second lateral portion 103b, 103c have a thickness 601, 602 lower with respect to the first thickness 600.

Preferably, at least one among the thickness 601 of the first lateral portion 103b and the thickness 602 of the second lateral portion 103c progressively reduces as it proceeds from the central portion 103a outwards, i.e. to the distal end of the lateral portion 103b, 103c.

The impact of an object to be transported 400 on the first lateral portion 103b and/or on the second lateral portion 103c determines an impact with an initial contacting surface 103y of the above-mentioned lateral portion 103b, 103c that is inclined with respect to the plane substantially detected by the central portion 103a.

Finally, it should be noted that at least part of the lower portion 101i of the supporting element 101 can comprise, or be, a thermal dissipator configured in particular to disperse at least part of the heat in use produced by the first electric motor 101m and by the second electric motor 101n.

In a preferred and non-limiting embodiment, at least part of the lower portion 101i can be realized in a material with high thermal conduction, for example in aluminum, or can integrate an active heat dissipator, for example a fan.

For this purpose, at least part of the lower portion 101i of the supporting element 101, can be provided with cooling wings.

The transporting device 100 object of the present disclosure is capable of moving objects at a high motion speed, for example up to 3 m/s, providing the possibility of de-stacking at least partially superimposed objects to be transported 400.

The transporting device 100 object of the present disclosure is cost-effective to realize, is very reliable and is composed of detachable parts that, in case of failure, can be singularly replaced without needing a replacement of the whole transporting device.

The data processing unit 202 controls each transporting device 100 with a low voltage control bus which realizes a primary control line and with an auxiliary control line which has the purpose of identifying all the transporting devices 100 present in the transporting system 200 and the type of each of them.

At the connection (installation) of the transporting device 100 in its own housing of the transporting system, this transporting device 100 is auto-addressed, i.e. the data processing unit 202 automatically assigns (without the need for user control) an address to the transporting device 100.

Upon starting the transporting system 200, the data processing unit acquires the electronic information relating to all the connected transporting devices 100 and, subsequently, runs an auto-addressing sequence to each one of said transporting devices 100.

In the auto-addressing sequence, an electronic message is transmitted by the data processing unit 202 and subsequently propagated by the transporting device 100 to the transporting device 100, until the exhaustion of the transporting devices 100.

Once the auto-addressing sequence has finished, the data processing unit 202 of the transporting system 200, automatically carries out a control procedure aimed at verifying the presence of eventually not addressed transporting devices 100.

Not addressed transporting devices 100 determine an interruption point in the transmission of the above-mentioned electronic message.

If all the transporting devices 100 have been correctly addressed, there will be no interruptions in the operation of the transporting system 200. Otherwise, instead, the data processing unit 202 will electronically identify the at least one interruption point corresponding to the transporting device 100 not correctly addressed.

If all the transporting devices 100 are have been correctly addressed, the data processing unit 200 can send appropriate commands of activation of the translator 103 and/or of rotation of the head portion 102 of one or more of the transporting devices 100, according to their address, for defining the motion path of one or more objects to be transported.

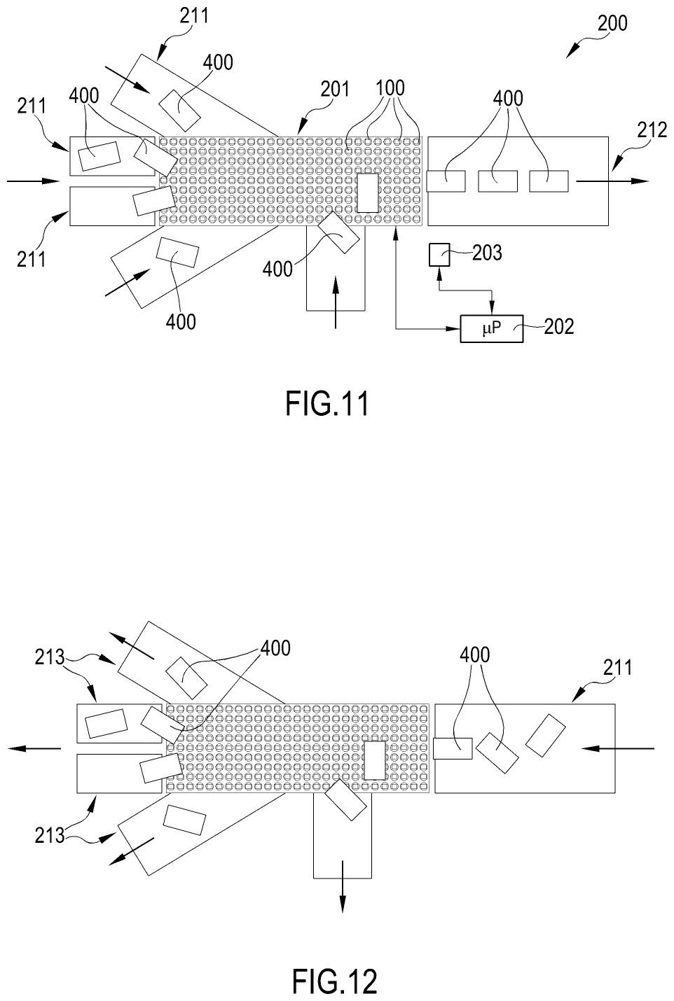

The transporting system 200 object of the present disclosure can be used to carry out a “conveying and/or transporting” function. This function is the conventional function of a conveyor belt, preferably without changes of direction. As schematically represented in FIG. 11, a plurality of objects to be transported 400 is provided on a plurality of loading tracks 211, and the assembly of transporting devices 100 addresses the plurality of objects to be transported 400 along a transporting direction 212.

The transporting system 200 object of the present disclosure also can be used to carry out a “sorting” function. This function is such that the plurality of objects to be transported 400 comes from a single loading track 211, and the objects to be transported 400 are sorted on a plurality of outlet tracks 213 according to a predetermined sorting criterion. This function is schematically represented in FIG. 12.

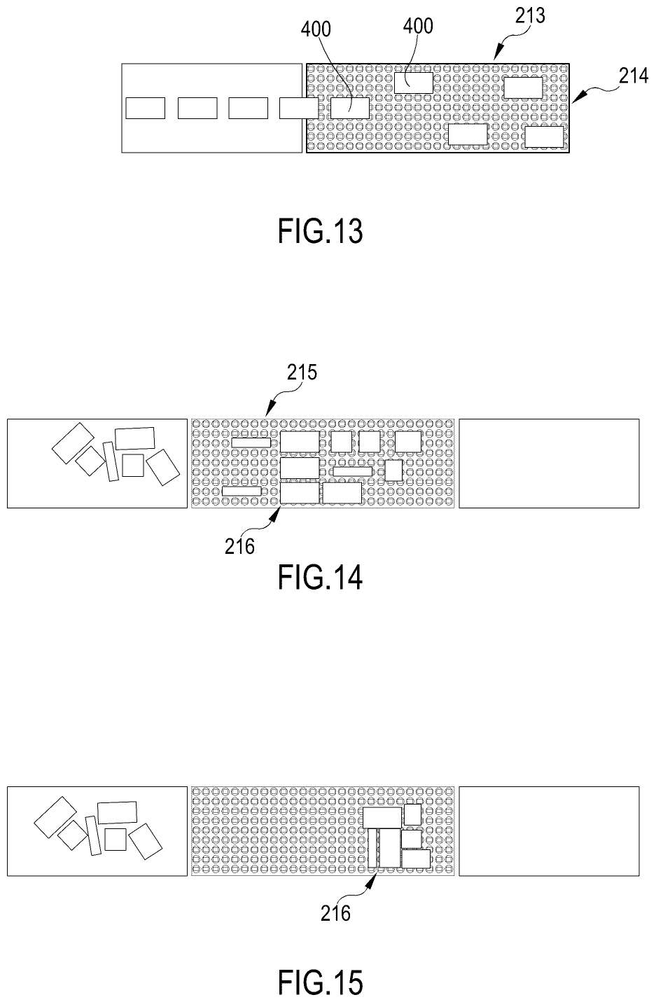

The transporting system 200 object of the present disclosure is also configured to carry out a singularization function. Such function is such that the plurality of objects to be transported 400 is singularized and from an original arrangement on several levels on a loading track 211 is arranged on one or more ordered flows 214, optionally parallel, and controlled in speed and/or reciprocal position. In the singularization function the relative position between two objects to be transported can be changed, and in particular reversed: objects that were originally arranged, in the forward direction, in such an order that a first object to be transported 400 was behind a second object to be transported, can be singularly moved in such a way that in the outlet track 213 the second object to be transported 400 lies behind the first object to be transported 400. This function is schematically represented in FIG. 13.

The transporting system 200 object of the present disclosure is configured to carry out a “cross-docking” function. In this case a plurality of objects to be transported 400, wherein these objects are aligned along a single direction in the single loading track 211, is moved in such a way that a first sub-portion 215 of said plurality of objects to be transported is arranged on a left row and a second sub-portion 216 of said plurality of objects to be transported is arranged on a right row. It is clearly foreseen, moreover, the inverse function. This function is schematically represented in FIG. 14.

The transporting system 200 object of the present disclosure is configured to carry out a palletizing/de-palletizing function: a plurality of objects to be transported 400 arranged in bulk on a single loading track 211 is oriented in such a way that a predetermined geometry 216 is formed, in correspondence of an outlet track. It is clearly foreseen, moreover, the inverse function. This function is schematically represented in FIG. 15. In the predetermined geometry, that in FIG. 15 is substantially of rectangular type, the objects to be transported 400 are in substantial contact. In the de-palletizing function, at least part of the transporting devices is used for orienting and/or translating the objects to be transported 400, so as to deconglomerate them, spacing them substantially from one another and/or randomly orienting them the one with respect to the other.

The invention is not limited to the embodiments of the figures; for this reason, the numbers and reference signs in the claims are provided for the sole purpose of increasing their intelligibility, and are non-limiting.

Finally, it is clear that additions, changes or variants to the object of the present disclosure, which are obvious for an expert in the art, can be applied without departing from the scope of protection provided by the attached claims.

1. A transporting device, comprising:
a supporting element configured to be fixed to a supporting structure;
a head portion connected to the supporting element, the head portion comprising at least a primary translator for objects to be transported, configured to translate said objects to be transported along at least one first predefined translation direction;
a rotation actuator configured to rotate said head portion with respect to said supporting element along a rotation axis inclined with respect to said first predefined translation direction;
wherein said transporting device is configured to singularize at least one first and one second object to be transported at least partially superimposed and respectively arranged at a first height and at a second height at least partially arranged in correspondence of said head portion determining a fall of said second object to be transported from said second height to said first height.

2. The device according to claim 1, further comprising a secondary translator configured to cause a translation of at least one part of said head portion, preferably at least said primary translator, along a direction substantially parallel to said rotation axis with respect to said supporting element; and
wherein said transporting device is configured to singularize said objects to be transported by means of at least one among an activation of said rotation actuator, an activation of said primary translator, an activation of said secondary translator, optionally by means of a composite and simultaneous, and/or sequential, movement of rotation of said head portion on said rotation axis and of translation along said predefined translation direction determined by the simultaneous, and/or sequential, activation, of said rotation actuator and of said primary translator, or by means of a composite and simultaneous, and/or sequential, movement of rotation of said head portion on said rotation axis and of translation along said rotation axis determined by the simultaneous, and/or sequential, activation, of said rotation actuator and of said secondary translator, or by means of a composite and simultaneous, and/or sequential, movement of translation along said predefined translation direction and along said rotation axis determined by the simultaneous, and/or sequential, activation, of said primary translator and of said secondary translator.

3. The device according to claim 1, wherein said rotation axis is orthogonal with respect to said first predefined direction, wherein said primary translator is configured to translate said objects to be transported along a predefined plane, wherein said first predefined translation direction lies on said predefined plane;
preferably wherein said supporting element comprises a lower portion and an upper portion rotatably engaged on said lower portion, said upper portion being configured to determine a dragging of said head portion in rotation on said rotation axis;
optionally said transporting device comprising engaging elements in form of rib and corresponding recess, arranged in correspondence of said upper portion of said supporting element and of said head portion, preferably of a base of the head portion, configured to be coupled by introduction and to determine the dragging of said head portion in rotation on said rotation axis.

4. The device according to claim 1, wherein said primary translator comprises at least one between a roller or a conveyor belt, and preferably comprises a plurality of flanked rollers or conveyor belts, preferably flanked along a direction oblique, optionally orthogonal, with respect to said predefined translation direction; and
wherein said head portion comprises a resting surface for said objects to be transported, configured to sustain at least part of the weight of said objects to be transported, and wherein said primary translator is substantially aligned to said resting surface or abuts at least partially at a height higher with respect to a height at which said resting surface lies;
said resting surface being substantially planar and/or said primary translator being at least partially arranged in correspondence of a central portion of the resting surface.

5. The device according to claim 1, wherein at least one among said rotation actuator, said primary translator and said secondary translator is configured to be actuated with a variable speed or acceleration;
preferably wherein said secondary translator comprises a vibrator, configured to determine a translation, optionally cyclic and/or reciprocating with an ascending and descending movement, of at least one between said primary translator and/or said head portion, said at least one first object to be transported, optionally said first object to be transported and said second object to be transported, along said rotation axis, or along a direction substantially parallel to said rotation axis; and/or
wherein said rotation actuator, said primary translator and said secondary translator are independently activatable.

6. The device according to claim 1, wherein said secondary translator is configured to determine a translation, optionally cyclic and/or reciprocating with an ascending and descending movement, along said rotation axis, or along a direction substantially parallel to said rotation axis, with a variable frequency between a first minimum value and a second maximum value.

7. The device according to claim 1, further comprising at least a use configuration wherein said primary translator and said secondary translator are activated in substantial simultaneity.

8. The device according to claim 2, wherein said supporting element comprises said rotation actuator, a first actuator for said primary translator and a second actuator for said secondary translator, and wherein said rotation actuator, said first actuator and said second actuator are electric actuators.

9. A transporting system, comprising:
a supporting structure configured to house a plurality of transporting devices as recited in claim 1 in a predefined spatial configuration, in such a way to realize a motion surface for said objects to be transported;
said transporting system comprising at least one data processing unit, operatively connected to said plurality of transporting devices and configured to activate, preferably simultaneously, at least part of said plurality of transporting devices according to a predefined scheme of activation destined to detect a motion path of said objects to be transported.

10. The transporting system according to claim 9, comprising at least one sensor configured to identify a superimposition of at least one first and one second object to be transported, respectively lying at said first height and said second height, said sensor being operatively connected, preferably electrically and/or optically connected, with said data processing unit;
said data processing unit, when said sensor identifies said superimposition, activates said at least part of said plurality of transporting elements for determining a fall at least of said second object from said second height to said first height.

11. The transporting system according to claim 9, wherein said supporting structure comprises a plurality of seats, optionally a plurality of recesses, each one configured to house a respective supporting element of a respective and single transporting device and wherein at least part of the head portions of the plurality of transporting devices lies on a same plane.

12. The transporting system according to claim 9, wherein the seats of said plurality of seats have a substantially circular section, and/or wherein said supporting element and/or said head portion defines a shape having a substantially circular section.

13. A Method for moving objects to be transported, comprising:
arranging at least one first object to be transported in correspondence of at least one transporting device as recited in claim 1;
carrying out an activation of said transporting device in order to move said at least one first object to be transported, determining a translation of said at least one first object to be transported along said first predefined translation direction and/or a rotation of said at least one first object to be transported with respect to said rotation axis, and/or a translation of said at least one first object to be transported along a direction substantially parallel to said rotation axis.

14. The method according to claim 13, further comprising:
arranging at least one second object to be transported in correspondence of said at least one transporting device, wherein the second object to be transported is arranged above said first object to be transported and lies at a second height higher with respect to a first height at which lies said first object to be transported;
wherein the activation of said transporting device, determines a fall of said second object to be transported from said second height to said first height.

15. The method according to claim 13,
wherein the activation of said transporting device comprises the activation of a secondary translator of said transporting device;
wherein the activation of said secondary translator determines a cyclic translation, and/or reciprocating with an ascending and descending movement, along a direction substantially parallel to said rotation axis of at least said head portion and/or of said primary translator;
and wherein said cyclic translation, and/or reciprocating with an ascending and descending movement, along a direction substantially parallel to said rotation axis determines a corresponding movement of translation along a direction substantially parallel to said rotation axis of said first object to be transported and of said second object to be transported.

16. The method according to claim 15, further comprising an activation of said secondary translator independently from said primary translator and/or in substantial simultaneity with said primary translator.

17. The method according to claim 15, wherein the activation of said secondary translator determines said translation, with a variable frequency between a first minimum value and a second maximum value.
